(19) United States
(12) Patent Application Publication
(10) Pub. No.: US 2007/0148058 A1
(43) Pub. Date: Jun. 28, 2007

(54) Exhaust gas purification device for motor vehicles

(75) Inventors: Thomas Buckel, Nurnberg (DE); Walter Stoepler, Herzogenaurach (DE)

Correspondence Address: LERNER GREENBERG STEMER LLP, P O BOX 2480, HOLLYWOOD, FL, 33022-2480, US

(73) Assignee: Faurecia Abgastechnik GmbH

(21) Appl. No.: 11/653,573

(22) Filed: Jan. 16, 2007

Related U.S. Application Data
(63) Continuation of application No. PCT/EP05/07127, filed on Jul. 1, 2005.

(30) Foreign Application Priority Data
Jul. 16, 2004 (DE) 10 2004 034 584.8
Apr. 19, 2005 (DE) 10 2005 017 881.2

(51) Int. Cl. B01D 50/00; F01N 3/10

(52) U.S. Cl. 422/180; 60/299

(57) ABSTRACT

An exhaust gas purification device for motor vehicles has a monolith which is disposed in a housing and has a front facade and a rear facade respectively extending transversely to the central longitudinal axis of the housing. A gap region is disposed between the monolith and a section of the housing. The monolith is directly or indirectly supported on by at least one facade on individual holding elements fixed to the housing. The holding elements extend approximately radially inwards and overlap the facade.

### CROSS-REFERENCE TO RELATED APPLICATIONS

This is a continuing application, under 35 U.S.C. §120, of international application PCT/EP2005/007127, filed Jul. 1, 2005, which designated the United States; this application also claims the priority, under 35 U.S.C. §119, of German patent applications DE 10 2004 034 584.8, filed Jul. 16, 2004 and DE 10 2005 017 881.2, filed Apr. 19, 2005; the prior applications are herewith incorporated by reference in their entirety.

### BACKGROUND OF THE INVENTION

### Field of the Invention

The invention relates to an exhaust gas purification device for motor vehicles having a monolith which is mounted in a housing and has a front end side and a rear end side which each extend transverse with respect to the central longitudinal axis of the housing. A gap space is present between the monolith and a housing section which embraces it. The monolith can be embodied, for example, as a catalytic converter, as an Noₓ accumulator, as a diesel particle filter or the like. In conventional exhaust gas devices there is a bearing mat in the gap space. What are referred to as swellable mats, that is to say mineral fiber mats with embedded granular expanded mica particles, are frequently used. However, other mat systems which are free of granular expanded mica are also employed. In all cases, particular importance is attached to the bearing mat which is disposed in the gap space and extends virtually over the entire length of a monolith, and this applies both to the axial and radial bearing of the monolith. In previous exhaust gas purification devices, it has therefore been possible only to use high quality bearing mats which are capable, for example, of compensating for varying gap space sizes during the operation of catalytic converter, the varying sizes resulting from different coefficients of thermal expansion of the monolith and the housing.

### SUMMARY OF THE INVENTION

It is accordingly an object of the invention to provide an exhaust gas purification device for motor vehicles which overcomes the above-mentioned disadvantages of the prior art devices of this general type, that has an alternative type of bearing for a monolith in which, for example, the requirements made of a bearing mat disposed in the gap space are reduced or in which it is possible to dispense entirely with using such bearing mats.

With the foregoing and other objects in view there is provided, in accordance with the invention, an exhaust gas purification device for motor vehicles. The exhaust gas purification device contains a housing having a central longitudinal axis, holding elements secured on the housing, and a monolith mounted in the housing. The monolith has end sides including, a front end side and a rear end side, each extending transverse with respect to the central longitudinal axis of the housing. The housing and the monolith define a gap space therebetween. The monolith is supported indirectly or directly with at least one of the end sides on the holding elements extending substantially radially inwards and overlapping the at least one end side.

The object is achieved in that the monolith is supported indirectly or directly at least with one end side on individual holding elements which are secured to the housing and which extend approximately radially inward and partially overlap the end side. It has become apparent that with this configuration, the monolith can be secured in the housing both in the axial direction and in the radial direction in such a way that less stringent requirements can be made of the bearing mat present in the gap space in terms of the holding forces exerted by the mat. It is possible to use relatively simple and cost effective mats, for example mats which serve mainly to provide thermal insulation. This can be achieved in particular if between the holding mat and the end side an intermediate element is disposed which prevents direct contact between the monolith fabricated generally from ceramic material and the metallic holding elements, and thus reduces the risk of abrasion of the ceramic monolith. Owing to the embodiment of the axial bearing of the monolith in the form of individual holding elements, the end side of the monolith is covered only to a relatively small degree and accordingly its inflow cross section or outflow cross section is reduced only to a small degree.

Intermediate elements which are elastically deformable and are composed, in particular, of a wire mesh, are preferably used. Such a material can be embodied in such a way that it has an axial compression region within which the restoring forces exerted by the material still ensure reliable bearing of the monolith. In this way, it is possible to compensate for length tolerances of the monolith.

The holding in the radial direction can be optimized if the intermediate elements have an axial section which extends into the gap space. By selecting the material and dimensioning the axial section it is possible to bring about reliable bearing of the monolith without the need for a bearing mat in the gap space. In another preferred embodiment, the axial section is configured as a ring which has one or more holding elements. Such an axial section prevents exhaust gas flowing through the gap space by bypassing the monolith. A further possible way of preventing such a bypass, which is to be additionally taken into account if appropriate, is to integrally form the holding element on the inner edge of a flange-like covering region which runs with its flat plane transversely with respect to the central longitudinal axis of the monolith and of the housing section embracing it and which at least partially covers the gap space.

A particularly preferred embodiment of the holding element provides for them to have a spring effect in the axial direction. As a result, length tolerances of the monolith and also thickness tolerances of intermediate elements can be compensated for. The rigidity or the spring effect of the holding elements can be brought about in different ways, for example by selecting a specific wall thickness, by use of reinforcing deeds, by constrictions or the like.

In a first preferred exemplary embodiment, the holding elements are integrally formed on indirectly or directly on the end side of the housing section which embraces the monolith. In a second preferred exemplary embodiment, the holding elements are part of a ring which is configured as a separate part and which is secured to the inner side or outer side of the housing section. One advantage of the two exemplary embodiments is, inter alia the fact that securing the monolith in the housing is completely independent of other components which are to be provided on the end side of the housing. The same unit can be used for exhaust gas devices which are configured in different ways, by virtue of the fact that, for example, depending on the type of use, housing funnels which are configured and dimensioned in different ways can be used. Providing housing funnels or connecting a plurality of units to intermediate pipe elements are relatively simple mounting activities compared to manufacturing or mounting a unit and they can be used in workshops with a relatively low technical standard.

Finally, in a third exemplary embodiment the holding elements are secured to a housing funnel which is provided on the inner side or outer side of the aforesaid housing. The housing funnel preferably bears in an axially secured fashion with an end section, on whose end side the holding elements are integrally formed, in an end section of the housing section which projects beyond the end side of the monolith. One advantage here is that at the same time as the housing funnel is connected to the housing, the monolith is secured by virtue of the fact that, specifically, the housing funnels are pressed with their holding elements against the end sides of the monolith with an application of axial force, and the housing funnels are secured to the housing when there is a predefined axial force or a predefined distance from the housing funnels.

Other features which are considered as characteristic for the invention are set forth in the appended claims.

Although the invention is illustrated and described herein as embodied in an exhaust gas purification device for motor vehicles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a first exemplary embodiment of an exhaust gas purification device with a unit which includes a housing section and a monolith mounted therein according to the invention;

FIG. 2 is a diagrammatic, plan view of an end side of the unit;

FIG. 3 is a diagrammatic, plan view of the end side of the unit which is modified compared to FIG. 2;

FIG. 4 is a diagrammatic, plan view of a further modification in the illustration corresponding to FIG. 2;

FIG. 5 is a diagrammatic, plan view of yet a further modification in the illustration corresponding to FIG. 2;

FIG. 6 is an illustration of detail VI shown in FIG. 2 but with differently configured holding elements;

FIGS. 7A and 7B are illustrations showing a sheet metal blank for forming the housing section which contains the monolith;

FIGS. 8A to 8D are diagrammatic, sectional views of an end side region of the unit, corresponding for example to the line VIII-VIII shown in FIG. 1, the illustrations clarifying different possible ways of connecting a housing funnel;

FIG. 9 is a diagrammatic, sectional view of the end edge region of the unit corresponding, for example, to the line VIII-VIII shown in FIG. 1;

FIG. 10 is a diagrammatic, plan view of an intermediate element shown in FIG. 9;

FIG. 11 is a diagrammatic illustration of a manufacturing method for the unit;

FIG. 12 is a schematic illustration of a method variant;

FIG. 13 is a diagrammatic, perspective view of the unit which is modified compared to FIG. 1;

FIG. 14 is a diagrammatic, sectional view of an end side region of the unit with a funnel fitted;

FIG. 15 is a diagrammatic, sectional view of the connecting region of two units which are connected to one another by a tubular connecting element;

FIG. 16 is an exploded, perspective view of a second exemplary embodiment, having the unit in which the holding elements are integrally formed on a separate ring;

FIG. 17 is a diagrammatic, cross-sectional view clarifying the manufacture of the unit shown in FIG. 16;

FIG. 18 is a diagrammatic, longitudinal sectional view of the unit from FIG. 16 with a housing funnel fitted;

FIG. 19 is a diagrammatic, longitudinal sectional view of a variant of the unit shown in FIG. 18 with the housing funnel fitted in an alternative way;

FIG. 20 is a diagrammatic, sectional view of a detail of the unit in which a ring which has holding elements is secured to the outer side of the housing section; and

FIGS. 21A and 21B are diagrammatic, sectional views of a third exemplary embodiment corresponding, for example, to the line VIII-VIII shown in FIG. 1, in which the holding elements are secured to a housing funnel.

### DESCRIPTION OF THE PREFERRED EMBODIMENTS

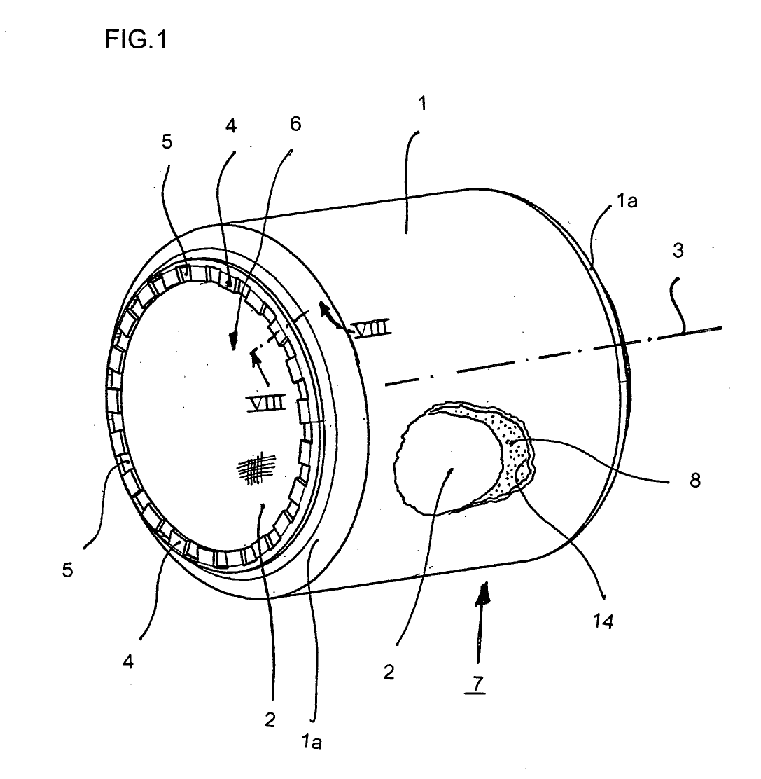

Referring now to the figures of the drawing in detail and first, particularly, to FIG. 1 thereof, there is shown a first exemplary embodiment of an exhaust gas purification device in which a housing section 1 which is substantially tubular shaped receives a monolith 2 which is fabricated from ceramic materials, has non-illustrated flow ducts running through it in a direction of its central longitudinal axis 3, and in which holding elements 4, which are distributed over a circumference of the housing section 1 and extend approximately radially inward, are integrally formed on end sides of the housing section 1. Distances 5 of equal size are present between the holding elements 4. By plastic deformation, the holding elements 4 are moved from an original position, from which they extend approximately parallel to the central longitudinal axis 3 into a position in which they apply a holding force to an end side 6 of the monolith 2. The holding elements 4 have, for example, an approximately rectangular or trapezoidal outline and are all configured in the same way. This also applies to the distances 5 between the holding elements 4. Furthermore, all holding elements 4 have the same thickness. Each of the holding elements 4 thus applies the same holding force to the monolith 2. The holding elements 4 can be disposed on both end sides of the monolith 2. The monolith 2 is then clamped in between the holding elements 4 in an axial direction, if appropriate with an intermediate positioning of elastic intermediate elements. It is also conceivable however for the monolith 2 to be supported only with one end side on the holding element 4 and with its other end side on a differently configured counterbearing, for example a ring which is secured to the housing section 1 and which covers the end side of the monolith in the radial direction to a certain degree. End regions 1a of the housing section 1 are drawn inward to such an extent that they cover a gap space 14 which is present between the monolith 2 and a wall of the housing section 1. This prevents exhaust gas from flowing through the gap space 14 by bypassing the monolith 2. If a bearing mat 8, for example a mineral fiber mat, is disposed in the gap space 14, the end regions 1a which is drawn inward prevent edges of the bearing mat 8 from being eroded by hot, pulsating exhaust gas. The housing section 1 forms, with the monolith 2 disposed therein, a unit 7 which can be used for the modular construction of exhaust gas devices. Different structural elements, for example a housing funnel 20, can be attached to the unit 7 on the inside and outside. Furthermore, two or even more units 7 can be combined to form relatively long assemblies using, for example, tubular section shaped connecting elements (see further below). It is also possible to combine units with different cleaning elements, for example oxidation catalytic converters and soot filters, with one another.

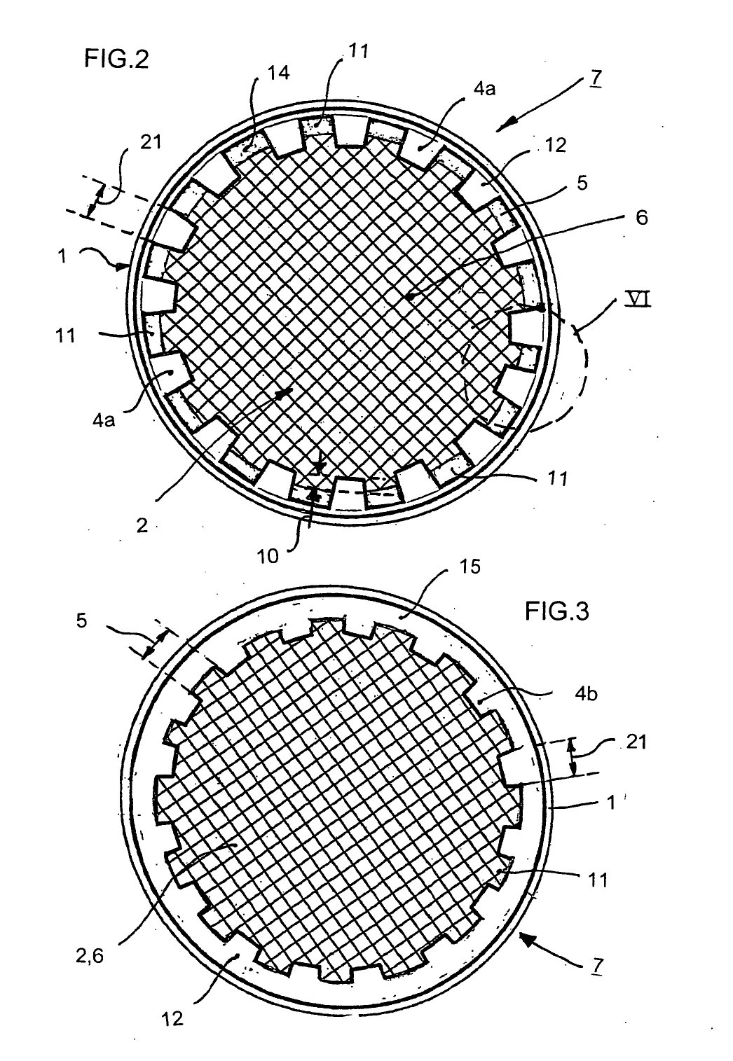

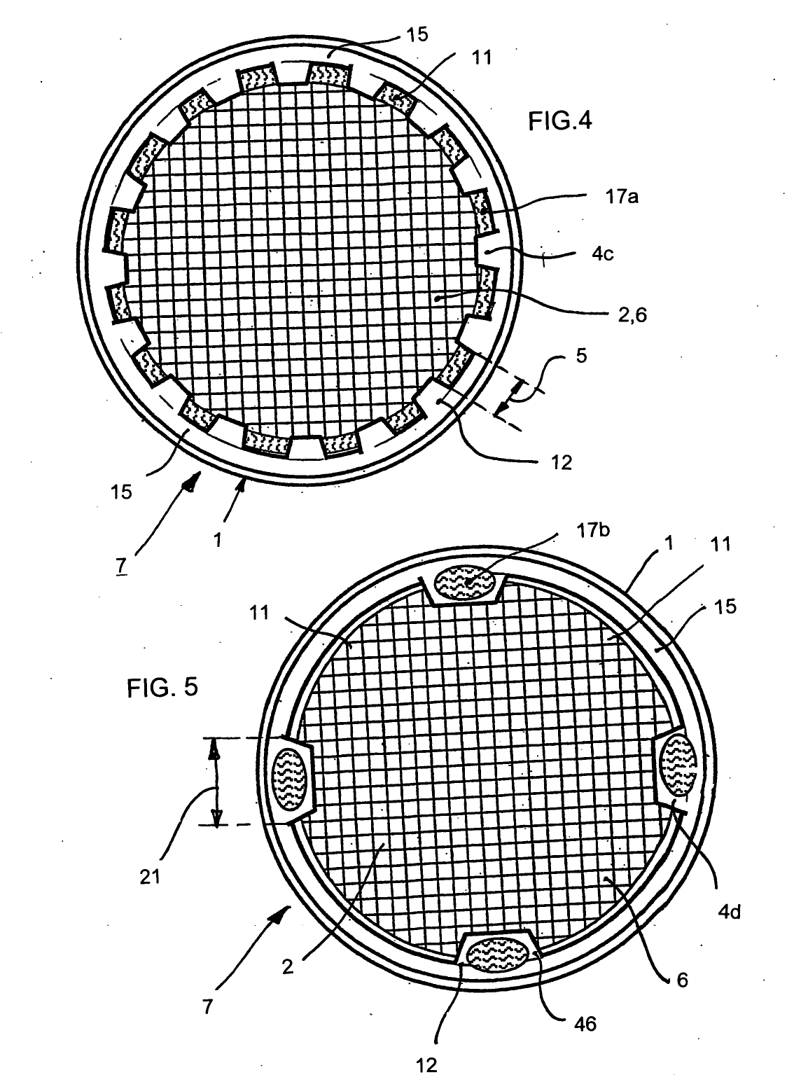

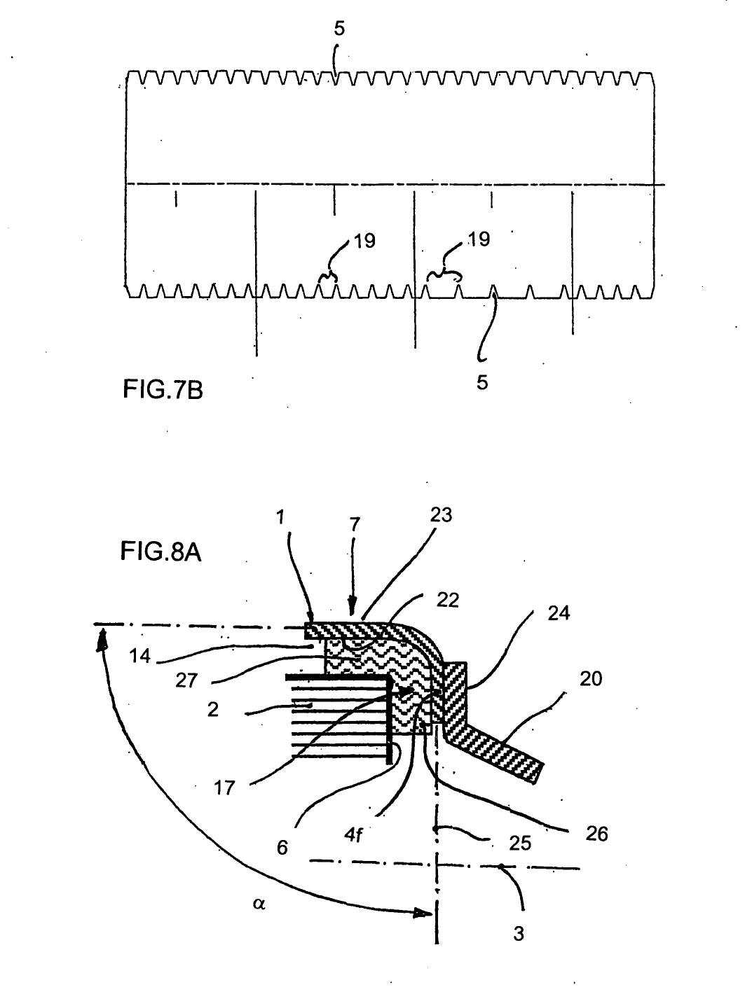

FIGS. 2 to 7B show, by way of example, various possible ways of configuring and disposing the holding elements on the housing section 1. In the example in FIG. 2, inwardly drawn-in end regions 1a are not present and instead the housing section 1 is configured in a cylindrical shape over its entire length, trapezoidal holding elements 4a which taper radially inward being integrally formed onto the end side of the housing section 1. In the premounted state, the holding elements 4 extend in the axial direction. After the abovementioned plastic deformation, they are directed radially inward and overlap the end side 6 of the monolith 2, and they bear, at least with part of an overlapping region 10, indirectly or directly on the end side 6 and apply to it the force which holds the monolith axially and radially. The housing section 1 in FIG. 2 is formed, for example, by a sheet metal cutout 13 as is shown in FIGS. 7A, 7B. In the initial state, the holding elements 4 extend in parallel with and coaxially to the central longitudinal axis 3 of the monolith 2 and of the housing section 1. The deformation occurs in such a way that the bend region extends substantially through a base 12 of the holding elements 4a. The gap space 14 which is present between the housing 1 and the monolith 2 is in this way covered only by the holding elements 4a. It is then conceivable to dispose a sealing element, for example in the form of a mineral fiber mat, at least in the end region of the monolith 2 in the gap space 14, in order to prevent exhaust gas flowing through the intermediate spaces 11 between the holding elements 4 and into the gap space 14 by bypassing the monolith 2.

In the embodiment variant in FIG. 3, not only holding elements 4b but also a covering region 15 which adjoins them in the axial direction in the initial state (see also FIG. 7A) are bent over to a certain extent in the radially inward direction. The covering region 15 at least partially covers the gap space 14, as is in the case in FIG. 3. However, it can also extend so far radially inward that the gap space 14 is closed off completely and exhaust gas is prevented from flowing in.

The holding elements 4 can, as already mentioned, bear indirectly or directly against the end side 6 of the monolith 2. However, it is often more expedient to place an intermediate element 17 in an intermediate position. An intermediate element 17a which is composed, for example, of the wire mesh can be configured in an annular shape and thus be disposed on the end side 6 of the monolith 2 in such a way that it extends as far as the inner side of the housing section 1 and in the process overlaps with the covering region 15, which is present if appropriate. The holding elements 4c are therefore not supported directly on the end side 6 of the monolith but rather on an intermediate element 17.

In the embodiment in FIG. 5, a total of four holding elements 4d are present distributed uniformly over the circumference of the housing section 1, the holding elements 4d also being integrally formed onto a covering region 15. The holding elements 4d have a larger width than those described further above. In each case an individual intermediate element 17b is disposed between the holding element 4d and the end side 6 of the monolith 2. The intermediate elements 17b which are normally not visible in a plan view of the end side of the unit 7 are visible for reasons of simplification, in FIG. 5, so that the holding elements 4d would appear to be transparent. The holding force which is applied to a monolith 2 in the embodiment variants of a plurality of holding elements 4a to 4c which is described above is applied, in the embodiment in FIG. 5, by significantly fewer holding elements 4d, specifically by a total of four. Correspondingly, the holding elements 4d have a greater degree of rigidity. This is achieved, inter alia, by correspondingly larger widths 21 of the holding elements 4d.

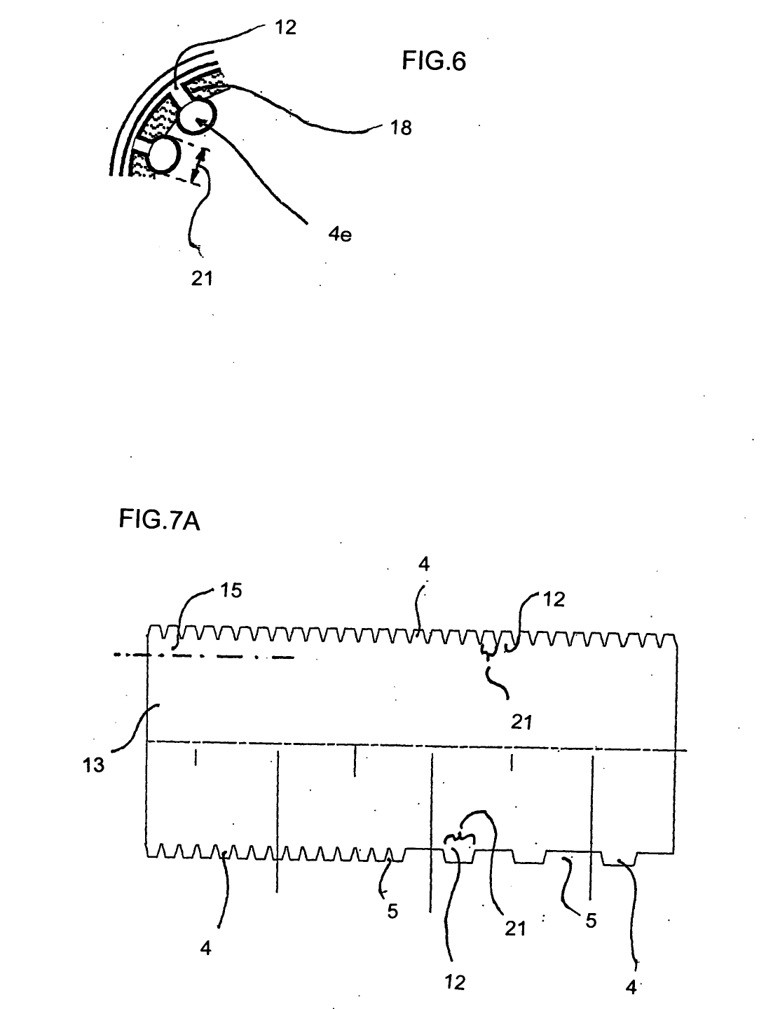

The rigidity of the holding element 4 can be generally influenced by various measures. For example, it is possible for there to be a constriction 18 present in the circumferential direction between the free end and the base 12 of a holding element 4e (see FIG. 6). Such a constriction 18 makes the holding 4e more elastic in the axial direction. The stiffness or the resulting force of the holding element can also be varied by its sheet metal thickness, by its width and by reinforcing elements in the form, for example of knobs, ribs or beads. The radius of the housing sector on which a holding element is integrally formed also has an influence on the rigidity of a holding element. The smaller the radius, the greater the rigidity of the holding element with a specific width. For example, FIGS. 7A, 7B illustrate a number of possible ways in which the width 21 of the holding elements 4 (measured at the base 12) and the distances 5 between the holding elements 4 can be varied. Uniform distribution of the holding forces over the end edge region of the monolith 2 can also be brought about by the aforesaid measures in an exhaust gas device embodied according to the invention.

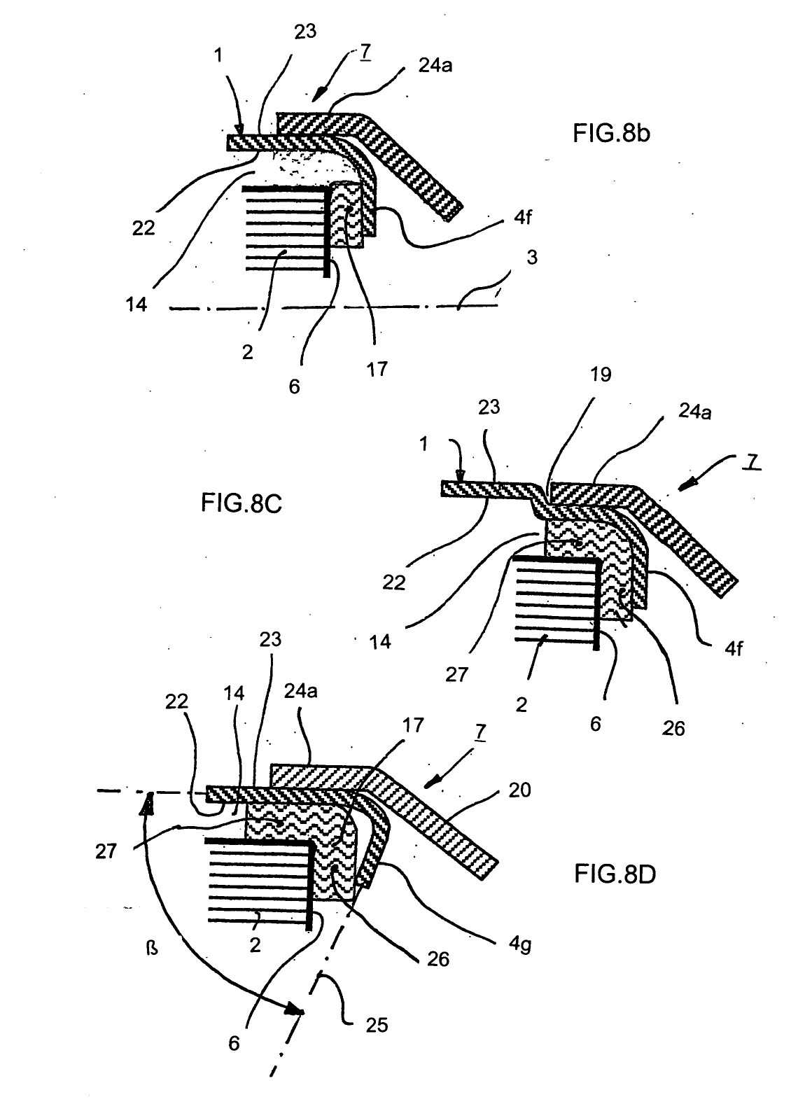

FIGS. 8A-8D show a number of examples of how a housing funnel 20 can be secured to the unit 7. In the embodiment variant in FIG. 8A, holding elements 4f are bent over in such a way that their flat plane 25 forms an angle α of approximately 90° with the central longitudinal axis 3. In these case, the outsides of the holding elements 4f form a surface which extends at right angles to the central longitudinal axis 3 and on which the housing funnel 20 can be mounted, for example welded on, by a securing section 24 which extends radially outward. In the embodiment variant in FIG. 8B, the securing section 24a extends parallel to the central longitudinal axis 3 and is secured to the outer side of the housing section 1. The configuration is similar in the exemplary embodiment according to FIG. 8C. Here, only a region 19 of the housing section 1 which accommodates the securing section 24 is drawn radially inwards so that the outer surface of the securing section 24a is approximately flush with the outer surface of the housing section 1.

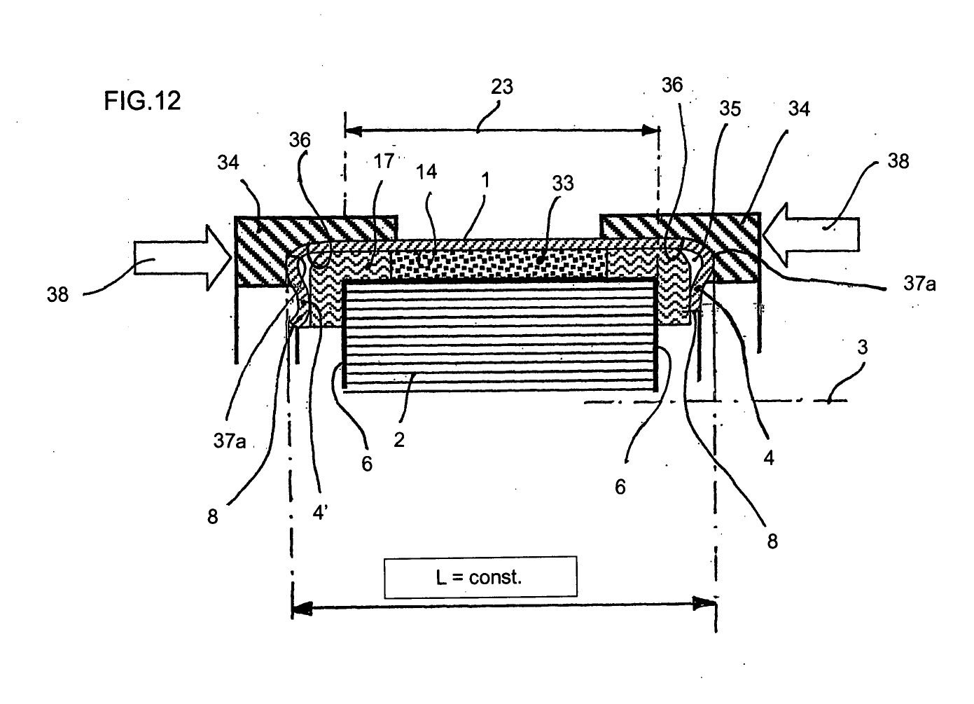

In the embodiment variant FIG. 8D, the housing funnel 20 is secured in the same way as in the embodiment variant in FIG. 8B. However, a difference is that the flat plane 25 of holding elements 4g forms, with an inner wall 22 of a bearing region 23 of the housing section 1 which accommodates the monolith, an angle β<90° which opens with respect to the end side 6 of the monolith 2. In this case, the holding element 4g bears just with its free end against the end side 6 or an intermediate element 17. Such a situation can also be brought about by a holding element not being planar but rather curved, as shown for example in FIG. 12.

As is apparent, for example, from FIG. 8A, the intermediate element 17 can have an axial section 27 which extends far into the gap space 14. Irrespective of whether the intermediate element 17 is embodied as a ring, or whether there are individual intermediate elements distributed in the circumferential direction of the monolith 2, for example as in the case in FIG. 5, it is possible in this way to bring about secure axial and radial bearing of the monolith 2 without a bearing mat being additionally positioned in the gap space 14. It is also conceivable for the axial section 27 to be missing from the intermediate element 17, as is the case in the embodiment variant in FIG. 8B. Such an embodiment is appropriate if the bearing mat 8 is present in the gap space 14 or if, despite the absence of such a mat, it is ensured that the monolith 2 is secured sufficiently in the axial and radial directions solely by the holding forces applied by the holding elements 4.

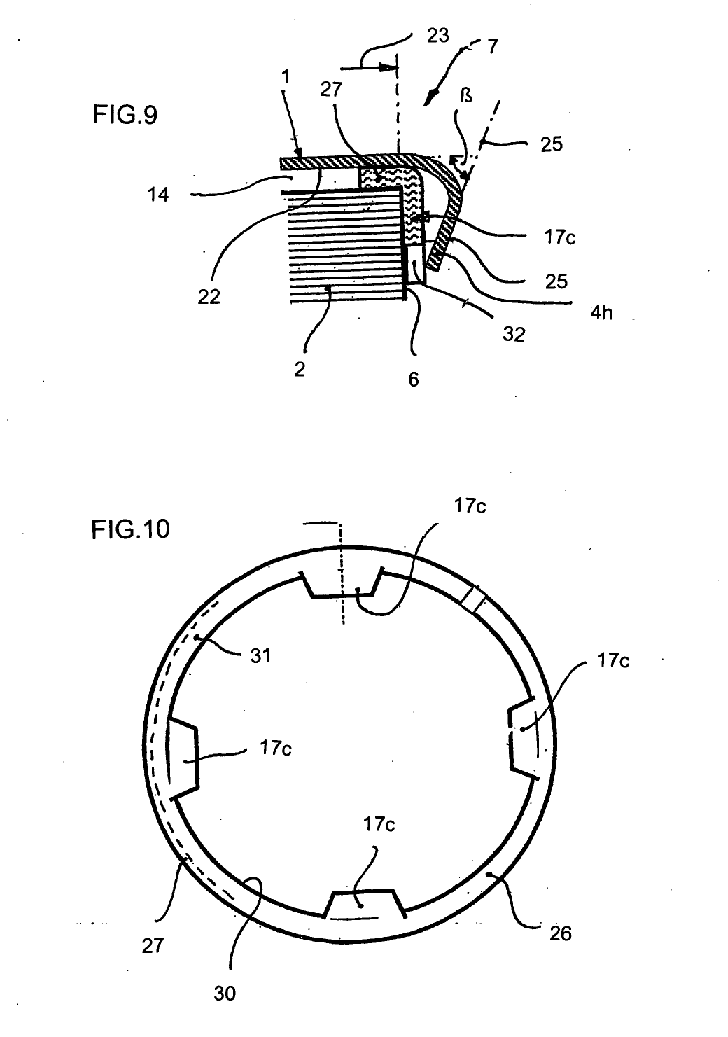

FIGS. 9 and 10 show an embodiment variant in which an annular axial section 27a which extends into the gap space 14 and which has holding elements 17c is present. An annular region 31 which covers the gap space 14 and from whose inner edge 30 intermediate element 17c protrude radially inward is formed onto the end side of the axial section 27a which points away from the gap space 14. The flat planes of the holding elements 17c enclose, with the inner wall 22 of the housing section 1, an angle β<90°. For this reason, they bear against the intermediate element 17c only with their free end. The holding element 17c can also be shaped or oriented differently.

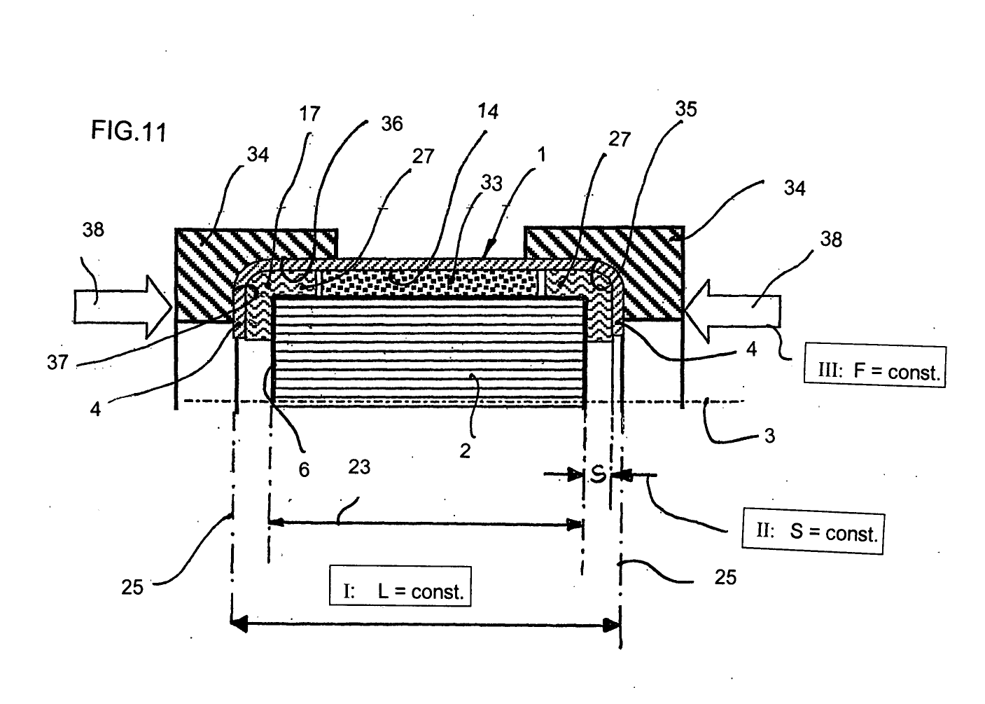

A method for manufacturing the unit 7 of the first exemplary embodiment will be explained in more detail below (FIGS. 11, 12): the housing section 1 is provided which is formed, for example, from sheet metal blanks 13 (FIGS. 7A, 7B). The holding elements 4 are formed by indents in the end side of the, for example, circular cylindrical housing section 1. The holding elements 4 thus extend parallel to the central longitudinal axis 3 or coaxially thereto in the initial state. The monolith 2 is inserted into the housing section 1, with the individual intermediate elements 17, an intermediate element 17a which is configured in an annular shape or an arrangement according to FIG. 10 being arranged at the end sides of the monolith 2. The bearing mat 8, for example a mineral fiber mat which does not swell, is disposed in the gap space 14. However, the bearing mat 8 can also be omitted if appropriate. Such a ready made housing section 1 is positioned between two mold halves 34 of a mold which can be moved axially with respect to one another. One mold half 34 has a recess 35, with a first and second wall section 36, 37. The first wall section 36 is configured so as to be complementary to the later outer contour of the ends of the housing section 1. In the method variant according to FIG. 11, the second wall section 37 extends at approximately a right angle to the first wall section 36. The holding elements 4 first bear, in the unbent state, with their end sides on the wall section 37. If the two mold halves 34 are moved toward one another in a direction of arrows 38 and force is applied to them, the holding elements 4 bend over radially inward, with their flat plane 25 extending approximately at a right angle to the central longitudinal axis 3 after the bending over has occurred. The intermediate elements 17 are elastic, i.e. they can be compressed in the axial direction. There are preferably individual wire mesh elements or in each case one wire mesh ring assigned to one end side.

In a first method variant I (FIG. 11), a constant distance is maintained between the two mold halves 34, between the wall regions 37. After the bending over of the holding elements 4, the housing sections 1 thus always have a same length L. Length tolerances of the monolith 2 and of the intermediate element 17 are compensated by the holding elements 4 which can bend elastically in the axial direction and by axially compressible elastic intermediate elements 17. Depending on the tolerance position, there are resulting slightly different holding forces applied by the holding elements 4. In a second method variant II, the mold halves 34 are moved close to one another to such an extent that a constant value is obtained for a gap S which is present between the end side 6 and the holding element 4. This method variant requires knowledge of the length of the individual monolith 2. In this case, the holding elements 4 merely have to compensate tolerances of the intermediate elements 17. Finally, in a third method variant III, the two mold halves 34 are moved toward one another with a constant force F. In the process, different compression curves of intermediate elements, for example of those made of wire mesh, are compensated and gaps S of different sizes are produced between the monolith 2 and holding element 4.

One possible way of compensating different monolith lengths or different intermediate element thicknesses (viewed in the axial direction) is provided by the method indicated in FIG. 12. The recess 35 in the mold halves 34 is configured in the manner of a groove, which is brought about, in particular, by a wall region 37a not being formed in a radial plane but rather approximately in a conical surface which tapers toward the end surface 6 of the monolith 2. The two mold halves 34 are moved together to a constant distance, in which case here the distance 1 between the points of the wall regions 37a which are furthest apart from one another in the axial direction is meant. Accordingly, after the bending process, the housing section 1 has the constant length L irrespective of the tolerances of the intermediate elements 17 and of the monolith 2. The curved embodiment of the wall regions 37a changes the shape of a holding element 4 in such a way that it bends radially inward, its free end striking the outside of an intermediate element 17 or the end side 6 of the monolith 2 and applying an axial force to it. Depending on the tolerance position, the holding element 4 is forced away elastically from the end side 6 of the monolith 2 counter to the direction of movement of the mold halves 34 (arrows 38).

In a longer monolith 2, the elastic deformation is more pronounced (FIG. 12, left-hand side) than in a shorter monolith 2 (FIG. 12, right-hand side). In relatively long monoliths 2, the holding element 4 can be bent over elastically in such a way that it has an approximately S-shaped profile in the cross section.

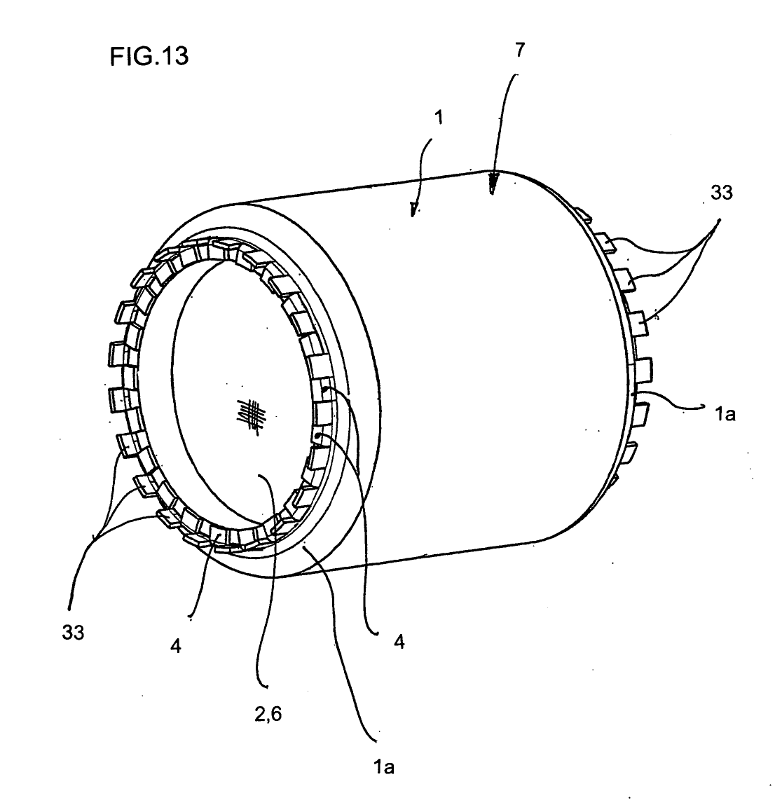

FIG. 13 shows an embodiment variant of the housing section 1 in which holding elements 4 alternate with securing clips 33 which protrude in the axial direction. The securing clips 33 serve to secure a housing funnel (not illustrated in FIG. 12). For this purpose, the housing funnel is fitted with a cylindrical end section onto the securing clips 33, for example in such a way that the inner surface of the end section bears against the outer surface of the securing clips 33.

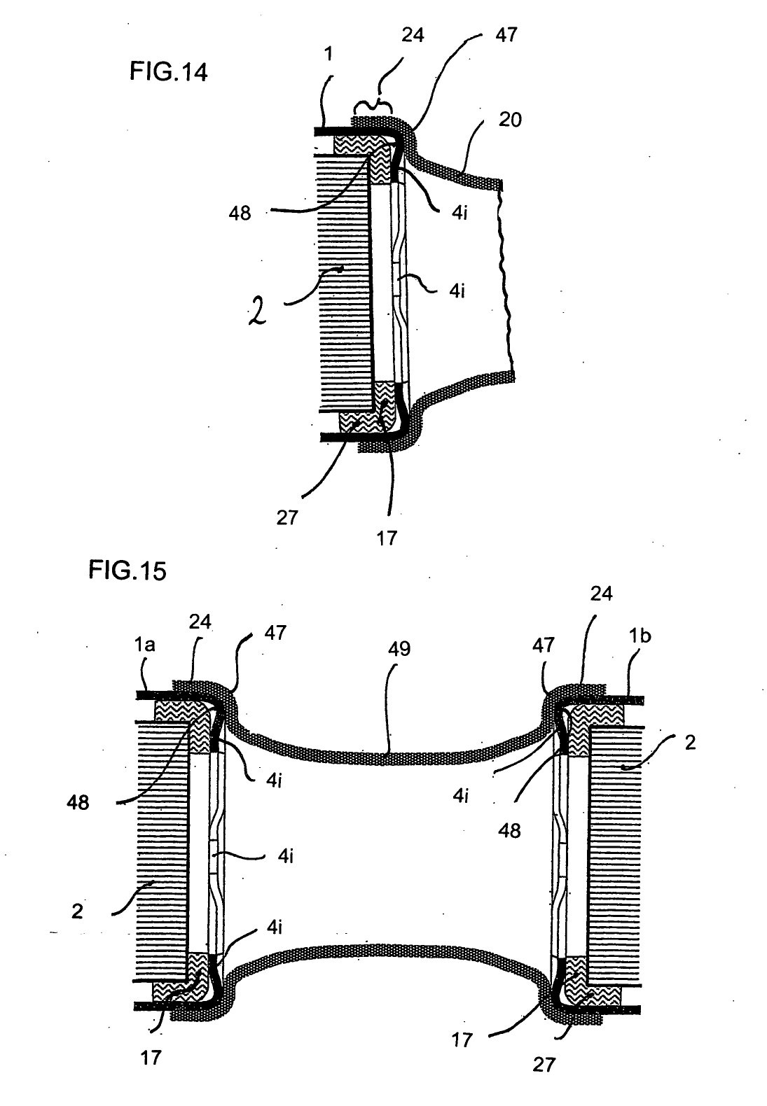

FIG. 14 shows an embodiment variant of an exemplary embodiment in which four holding elements 4i distributed uniformly in the circumferential direction are formed approximately corresponding to FIG. 8D. The housing funnel 20 with a cylindrical securing section 24 is fitted onto the outer side of the housing section 1. This is adjoined by a radially inwardly curved region 47 whose inner side which faces the monolith 2 is formed so as to be complementary to the curved region 48 of the holding element 4i. This embodiment mechanically stabilizes the holding elements 4i. Depending on how far the region 47 bears against the region 48 when viewed in the radial direction, it is possible to influence the rigidity of the holding elements 4i to a greater or lesser extent.

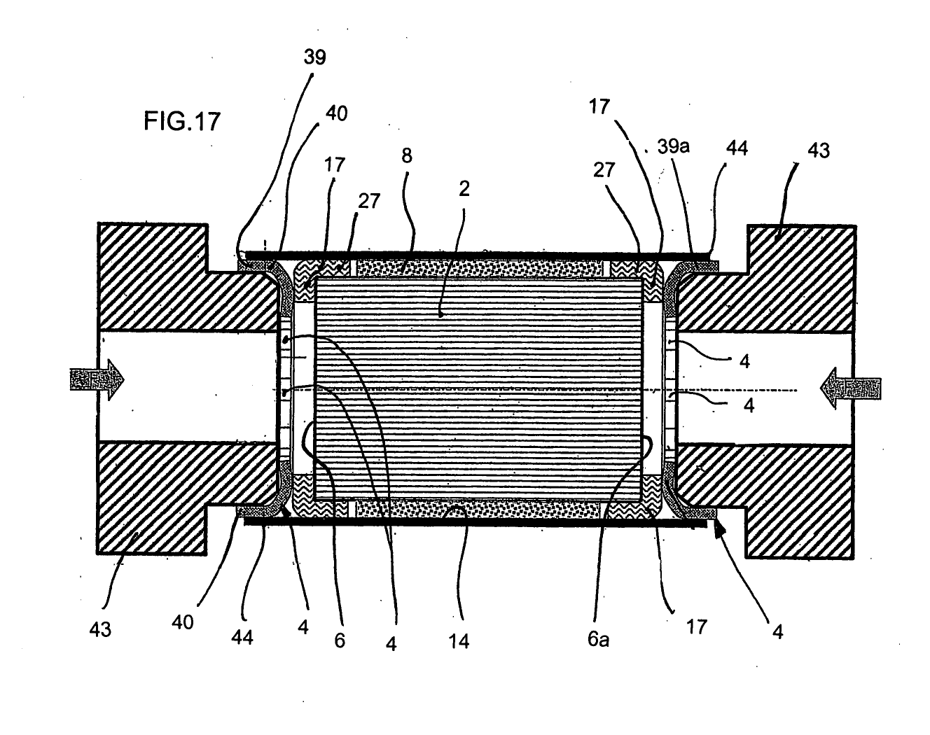

In a further variant of the exemplary embodiment, two housing sections 1a, 1b are connected to one another via an intermediate tubular element 49 (FIG. 15). The end sections of the intermediate tubular element 49 are configured so as to correspond to the end section of the housing funnel 20 in FIG. 17, that is to say have a radially inwardly curved region 47. The latter bears against a region 48 of the holding elements 4i which is curved in a complementary fashion.

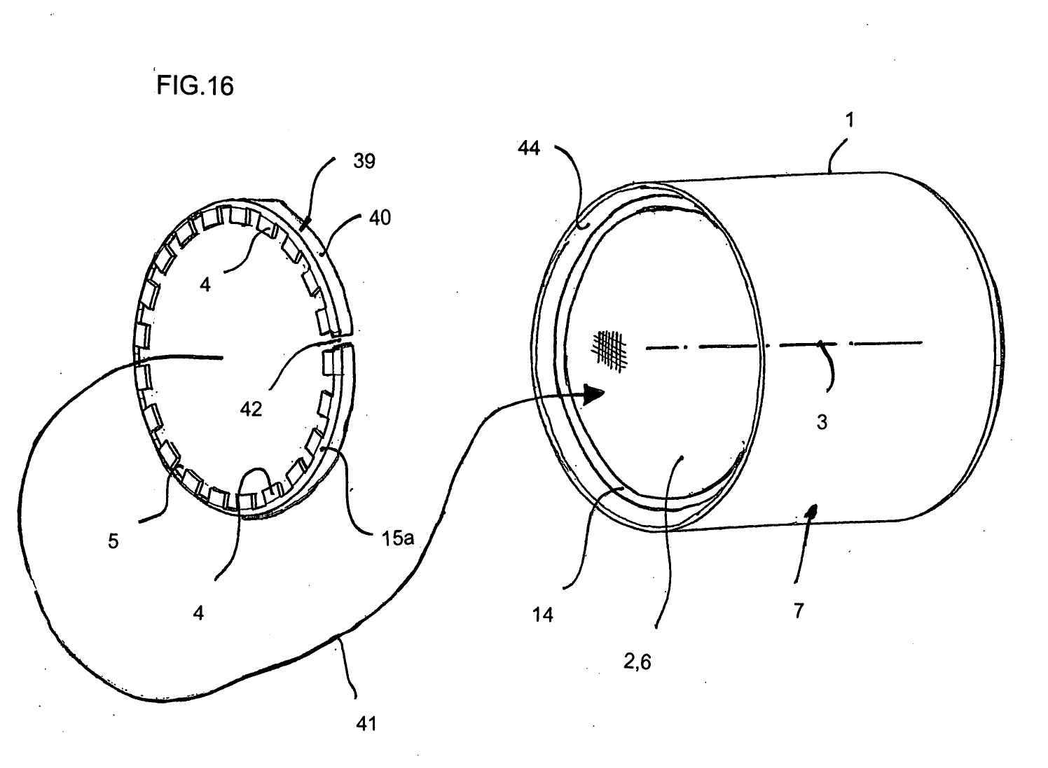

FIG. 16 shows a second exemplary embodiment in which the holding elements 4 are not connected in one piece to the housing section 1 but rather formed integrally on a separate ring 39.

The ring 39 has an approximately L-shaped crosssectional profile, one of whose limbs is an apron 40 which extends coaxially to the central longitudinal axis 3 of the housing 1 and the other limb of which extends transversely thereto or in a radial plane and forms a covering region 15a which closes off the gap space 14. The holding elements 4 project approximately radially inward from the inner edge of the covering region 15a. What was stated furtherabove applies analogously to the embodiment and rigidity of the holding elements. In particular, the holding elements can extend approximately at a right angle to the central longitudinal axis 3 or have a curved shape, for example as in FIG. 12. The ring 39, which is shown separately in FIG. 16, is rotated through 180° in the direction of arrow 41 and fitted onto the housing section 1, with the apron 40 extending away from the end side 6 in the mounted state. As is also the case in the examples described above, a bearing mat, an insulating mat or even no mat at all can be arranged in the gap space 14. A ring 39, 39a (FIG. 17) which can be closed or open (slot 42) can be inserted, with the holding elements 4 at the front, preferably with the intermediate position of an intermediate element 17, into each side of the housing section 1.

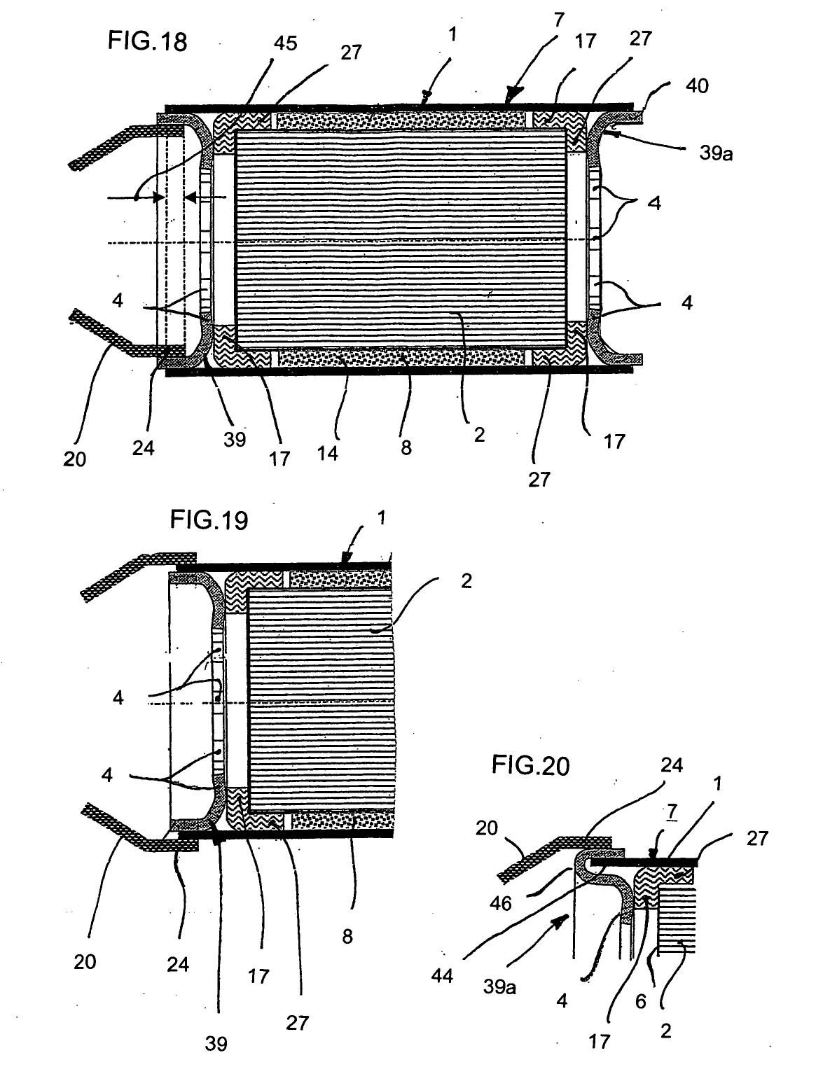

For the rest of the mounting process, the following procedure is adopted: the two rings 39, 39a of the respective end side 6, 6a of the monolith 2 have an axial force F applied to them with an axial compression of the intermediate element 17. This can be done, as shown in FIG. 17, using two dies 43 which apply axial forces to the rings 39, 39a. It is also conceivable for one of the dies to serve as a fixed brace and for the axial force to be applied by the other die. Force is applied to the rings 39, 39a until either a predefined axial holding force or a predefined distance is brought about between the rings 39, 39a. The rings 39, 39a are then secured, for example by spot welding, to the inner surface of housing ends 44 which project beyond the end sides of the monoliths 2. The aprons 40, extending in the axial direction, of the rings 39, 39a have such a length that the housing funnel 20 can easily be secured, preferably welded, onto their inner side (FIG. 18). The length of the apron 40 is also dimensioned such that there is a certain degree of axial play 45 for axially positioning the housing funnel 20 or for setting the overall length of an exhaust gas purification device which is completed with housing funnels 20. The housing funnel 20 can also be secured on the outer side of a ring 39, 39a if its apron 40 projects far enough beyond the respective housing ends 44 (not illustrated). Finally, the housing funnel 20 can be secured with its securing section 24 on the outer side of the housing section 1, as is shown in FIG. 19. It is conceivable that just one of the two rings 39, 39a has holding elements 4 and, in contrast, the other ring has, instead of the holding elements, a limb which is coherent in the circumferential direction and on which the monolith 2 is supported (not illustrated).

FIG. 20 shows an embodiment variant in which a ring 39b which has holding elements 4 is secured to the outer side of the housing section 1. The ring 39b is formed by an annular U section 46 on whose inner limb holding elements 4 are integrally formed. The U section 46 is fitted over the housing end 44 of the housing section 1 and secured by the inner side of the external limb to the outer side of the housing end 44, for example welded on. The housing funnel 20 embraces the U section 46 with its securing section 24 and is secured to its outermost limb.

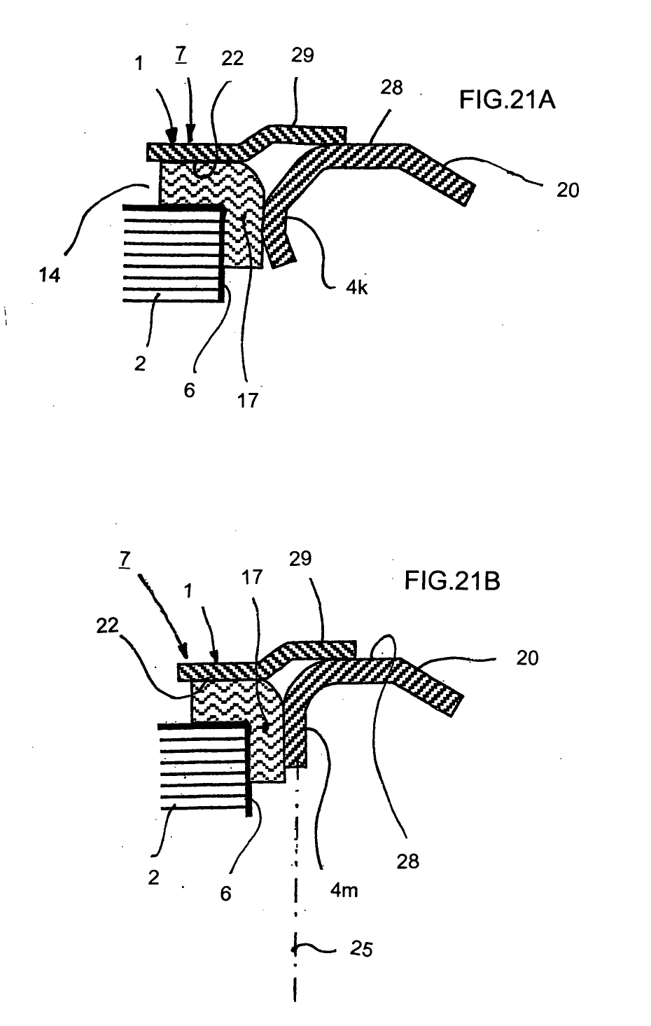

FIGS. 21A and 21B show a third exemplary embodiment in which the holding elements 4k and 4m are integrally formed onto the end sides of the housing funnel 20. As is also the case in the exemplary embodiments described above, the plane 25 of a holding element 4k can also extend at a right angle to the central longitudinal axis 3. However, it is also conceivable, as shown in FIG. 21A for the holding elements 4k to be curved, with the convex part of the curvature facing the monolith 2. The holding elements 4k, 4m can also be bent over in the radially inner direction from an original axially extending orientation by plastic bending. What is stated above applies analogously to the embodiment of the holding elements 4k, 4m and the influencing of their rigidity or spring effect. The housing funnels 20 have an approximately cylindrical end section 28 onto whose end side the holding elements 4k, 4m are integrally formed. The end section 28 is fitted into an end section 29 of the housing section 1 which projects axially beyond the end side 6 of monolith 2 and is, for example, widened. For the purpose of mounting, the housing funnels are pressed with an axial force with their holding elements 4k, 4m against the end side 6 or against the intermediate elements 17 and secured to the housing section, for example welded on, when a predefined axial force or a predefined axial distance is brought about between the housing funnels 20.

We claim:

1. An exhaust gas purification device for motor vehicles, the exhaust gas purification device comprising:
a housing having a central longitudinal axis;
holding elements secured on said housing; and
a monolith mounted in said housing, said monolith having end sides including, a front end side and a rear end side, each extending transverse with respect to said central longitudinal axis of said housing, said housing and said monolith defining a gap space therebetween, said monolith supported one of indirectly and directly with at least one of said end sides on said holding elements extending substantially radially inwards and overlapping said at least one end side.

2. The exhaust gas purification device according to claim 1, further comprising an intermediate element disposed between said holding elements and said at least one end side.

3. The exhaust gas purification device according to claim 2, wherein said intermediate element is an elastically deformable intermediate element.

4. The exhaust gas purification device according to claim 3, wherein said intermediate element is composed of a wire mesh.

5. The exhaust gas purification device according to claim 2, wherein said intermediate element is one of a plurality of intermediate elements each having an axial section extending axially into said gap space.

6. The exhaust gas purification device according to claim 2, further comprising an axial section formed as a ring and bears at least one said intermediate element.

7. The exhaust gas purification device according to claim 1, further comprising a cover region having an inner edge and embodied as an annular flange, said holding elements being integrally formed on said inner edge of said cover region, said cover region extending with its flat plane transversely with respect to said central longitudinal axis and at least partially closes off said gap space.

8. The exhaust gas purification device according to claim 1, wherein said holding elements are configured to have a spring effect in an axial direction.

9. The exhaust gas purification device according to claim 8, wherein said at least one end side is assigned a plurality of said holding elements each having said spring effect of differing magnitudes.

10. The exhaust gas purification device according to claim 8, wherein said holding elements have a base, a free end and a constricted portion in a circumferential direction, said constricted portion is disposed between said free end and said base.

11. The exhaust gas purification device according to claim 1, wherein said holding elements are disposed at different distances from one another.

12. The exhaust gas purification device according to claim 1, wherein said holding elements are integrally one of indirectly formed and directly formed on said at least one end side of said housing embracing said monolith.

13. The exhaust gas purification device according to claim 1, further comprising a housing funnel disposed on one of an inlet side and an outlet side of said housing, said holding elements being secured to said housing funnel.

14. The exhaust gas purification device according to claim 13, wherein:
said housing has a housing end section protruding beyond said at least one end side of said monolith; and
said housing funnel has a funnel end section resting in an axially secured fashion to said housing end section, said holding elements being integrally formed onto said funnel end section at said at least one end side of said monolith.

15. The exhaust gas purification device according to claim 1, wherein said holding elements form part of a ring which is embodied as a separate part and is secured to one of an inner side and an outer side of said housing.

16. The exhaust gas purification device according to claim 15, wherein said ring has an axially extending apron with an outer side connected to said inner side of said housing.
